(19) United States
(12) Patent Application Publication
(10) Pub. No.: US 2013/0028189 A1
(43) Pub. Date: Jan. 31, 2013

(54) METHOD AND APPARATUS FOR USING PHYSICAL LAYER ERROR CONTROL TO DIRECT MEDIA ACCESS LAYER ERROR CONTROL

(71) Applicant: Yair Bourlas, San Diego, CA (US)

(72) Inventor: Yair Bourlas, San Diego, CA (US)

(73) Assignee: WI-LAN INC., Ottawa (CA)

(21) Appl. No.: 13/632,717

(22) Filed: Oct. 1, 2012

Related U.S. Application Data
(63) Continuation of application No. 12/493,018, filed on Jun. 26, 2009.
(60) Provisional application No. 61/076,360, filed on Jun. 27, 2008.
(60) Provisional application No. 61/095,580, filed on Sep. 9, 2008.

(51) Int. Cl. H04W 4/00

(52) U.S. Cl. 370/328

(57) ABSTRACT

In a system in which both the media access layer and the physical layer use error control, information from the physical layer error control process is used to provide surrogate media access layer error control messaging. In one aspect, the physical layer error control state machine in the transmitting station sends the surrogate message internally to the media access layer error control state machine based on physical layer error control results, thereby eliminating a need to transmit the error control messaging from the media access layer error control state machine of the receiving station over the wireless link.

### CROSS REFERENCE TO RELATED APPLICATIONS

This application is a continuation of U.S. patent application Ser. No. 12/493,018, filed Jun. 26, 2009, which claims the benefit of U.S. Provisional Application No. 61/076,360, filed Jun. 27, 2008 and U.S. Provisional Application No. 61/095,580, filed Sep. 9, 2008, which are incorporated by reference as if fully set forth.

### BACKGROUND

I. Field of the Invention

The invention relates to the field of wireless communications. More particularly, the invention relates to error control in a wireless communication system.

II. Related Art

In a wireless communication system, the most precious resource, in terms of both capital cost and performance, is often the wireless link itself. Thus, it is important to use the wireless link resources efficiently.

### BRIEF SUMMARY

In a system in which both the media access layer and the physical layer use error control, information from the physical layer error control process is used to provide surrogate media access layer error control messaging. In one aspect, the physical layer error control state machine in the transmitting station sends the surrogate message internally to the media access layer error control state machine based on physical layer error control results, thereby eliminating a need to transmit the error control messaging from the media access layer error control state machine of the receiving station over the wireless link.

### BRIEF DESCRIPTION OF THE DRAWINGS

FIG. 1 is a simplified functional block diagram of an embodiment of a wireless communication system.

FIG. 2 is a block diagram illustrating a downlink service flow configuration that can be implemented in the system of FIG. 1 in accordance with one embodiment of the invention.

FIG. 3 is a block diagram illustrating an uplink service flow configuration that can be implemented in the system of FIG. 1 in accordance with one embodiment of the invention.

FIG. 4 is a simplified flowchart showing physical layer operation within the base station for the downlink (DL) transmission in accordance with one embodiment of the invention.

FIG. 5 is an exemplary flow chart showing MAC layer operation at the base station in the DL transmission.

FIG. 6 is an exemplary flow chart showing physical layer operation on the client station or transmitting station during the uplink (UL) operation.

FIG. 7 is an exemplary flow chart showing physical layer operation on the base station (receiving station) during the UL operation.

FIG. 8 is an exemplary flow chart showing MAC layer operation at the client station (transmitting station) during the UL operation.

### DETAILED DESCRIPTION OF EMBODIMENTS OF THE INVENTION

The physical (PHY) layer is the lowest layer protocol layer in a communication system. It provides the means of transmitting raw bits over the communication link. In a wireless system, the PHY layer provides an interface between the medium access layer (MAC) and the wireless link. It performs such functions as electromagnetic spectrum frequency allocation, specification of signal strength and the like. It also provides the modulation and coding scheme, forward error correction and the like.

At the transmitting station, the PHY layer receives MAC packet data units (PDUs) from the MAC layer. Typically the MAC PDUs are smaller than the largest available PHY layer packet. As such, the PHY layer at the transmitting station may combine multiple MAC PDUs into one PHY packet before transmitting the PHY packet over the wireless link. The PHY layer at the receiving station extracts the corresponding MAC PDUs and passes them to the MAC layer in the receiving station.

The MAC layer provides addressing and channel access control mechanisms that make it possible for several receivers or client stations to communicate with a base station. The MAC layer is typically largely unaware of the PHY layer operation and, as such, a common MAC layer may be used in systems using disparate PHY layer techniques. For example, the MAC layer is unaware of the packing of multiple MAC PDUs into one PHY packet at the PHY layer.

Automatic Repeat-Request (ARQ) is an error control method for data transmission. ARQ can be applied to either the MAC layer or the PHY layer. It uses acknowledgments (ACKs), negative acknowledgment (NACKs) and timeouts to achieve reliable data transmission. An acknowledgment indicates that a receiving station has correctly received MAC PDU or PHY packet. A negative acknowledgment indicates that the receiving station was unable to properly receive a MAC PDU or PHY packet. A timeout is a time counter that is activated when the transmitting station sends the PDU or packet and expires at the latest point in time at which the transmitting station reasonably expects to receive an ACK from the receiving station. If the transmitting station does not receive an acknowledgment before the timeout expires, it usually re-transmits the PDU or packet until it receives an acknowledgment or a predefined number of re-transmissions have occurred.

Hybrid ARQ (HARQ) is a variation of ARQ which has better performance, particularly over wireless channels, at the cost of increased implementation complexity. HARQ can be applied to the PHY layer only. HARQ also uses ACKs or NACKs as receiving or non-receiving indicators. Some HARQ protocol also uses timeouts. However, according to HARQ operation, when a receiving station fails to properly receive a packet, it saves the energy associated with the failed transmission and combines it with the energy received in subsequent transmissions of the same packet.

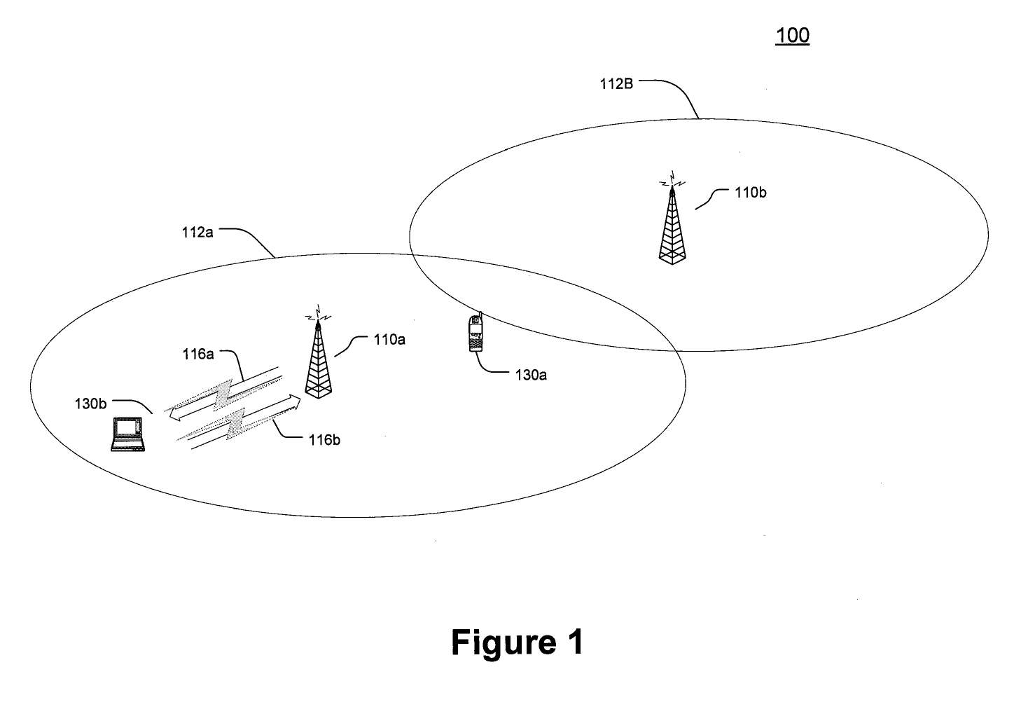

FIG. 1 is a simplified functional block diagram of an embodiment of a wireless communication system 100. The wireless communication system 100 includes a plurality of base stations 110a, 110b, each supporting a corresponding service or coverage area 112a, 112b. Each base station, e.g., 110a or 110b, can be coupled to one another and a supporting network (not shown) via a combination of wired and wireless links. The base station, for example 110a, can communicate with wireless devices within its coverage area 112a. For example, the first base station 110a can wirelessly communicate with a first client station 130a and a second client station 130b within the coverage area 112a over a downlink 116a and an uplink 116b.

Although for simplicity only two base stations are shown in FIG. 1, a typical wireless communication system 100 includes a much larger number of base stations. The base stations 110a and 110b can be configured as cellular base station transceiver subsystems, gateways, access points, radio frequency (RF) repeaters, frame repeaters, nodes or any wireless network entry point.

Although only two client stations 130a and 130b are shown in the wireless communication system 100, typical systems are configured to support a large number of client stations. The client stations 130a and 130b can be mobile, nomadic or stationary units. The client stations 130a and 130b are often referred to as, for example, mobile stations, mobile units, subscriber stations, wireless terminals or the like. A client station can be, for example, a wireless handheld device, a vehicle mounted device, a portable device, client premise equipment, a fixed location device, a wireless plug-in accessory or the like. In some cases, a client station can take the form of a handheld computer, notebook computer, wireless telephone, personal digital assistant, wireless email device, personal media player, meter reading equipment or the like and may include a display mechanism, microphone, speaker and memory.

In one example, the wireless communication system 100 is configured for Orthogonal Frequency Division Multiple Access (OFDMA) communications. For example, the wireless communication system 100 can be configured to substantially comply with a standard system specification, such as an IEEE 802.16 type standard (some embodiments of which are commonly referred to as WiMAX), long term evolution (LTE) standard or some other wireless standard or it can be a proprietary system.

The wireless communication system 100 is not limited to an OFDMA system, and use of the techniques described herein is independent of the multiple access scheme used in the system. The description is offered for the purposes of providing a particular example of the operation of certain aspects of the invention.

Each base station, for example 110a, can supervise and control the communications within its respective coverage area 112a. Each active client station (e.g., 130a) registers with a base station (e.g., 110a) upon entry into its coverage area (e.g., 112a). Typically, the client station 130a can notify the base station 110a of its presence upon entry into the coverage area 112a, and the base station 110a can interrogate the client station 130a to determine the capabilities of the client station 130a.

When, for example, the client station 130a establishes a service flow, such as an Internet connection or a voice connection, with the base station 110a, a MAC layer service flow state machine is established in both the client station 130a and the base station 110a. Sometimes the MAC layer is configured to detect MAC layer errors, regardless of the error control techniques used on the PHY layer. For example, according to one configuration of WiMAX which can be referred to as ARQ over HARQ, the system uses ARQ in the MAC layer and HARQ in the PHY layer for error control purposes. However, such configurations result in an inefficient use of the precious wireless link resource. As described herein, one aspect of the present invention reduces the overhead associated with, and thus increases the efficiency of, the ARQ over HARQ configuration.

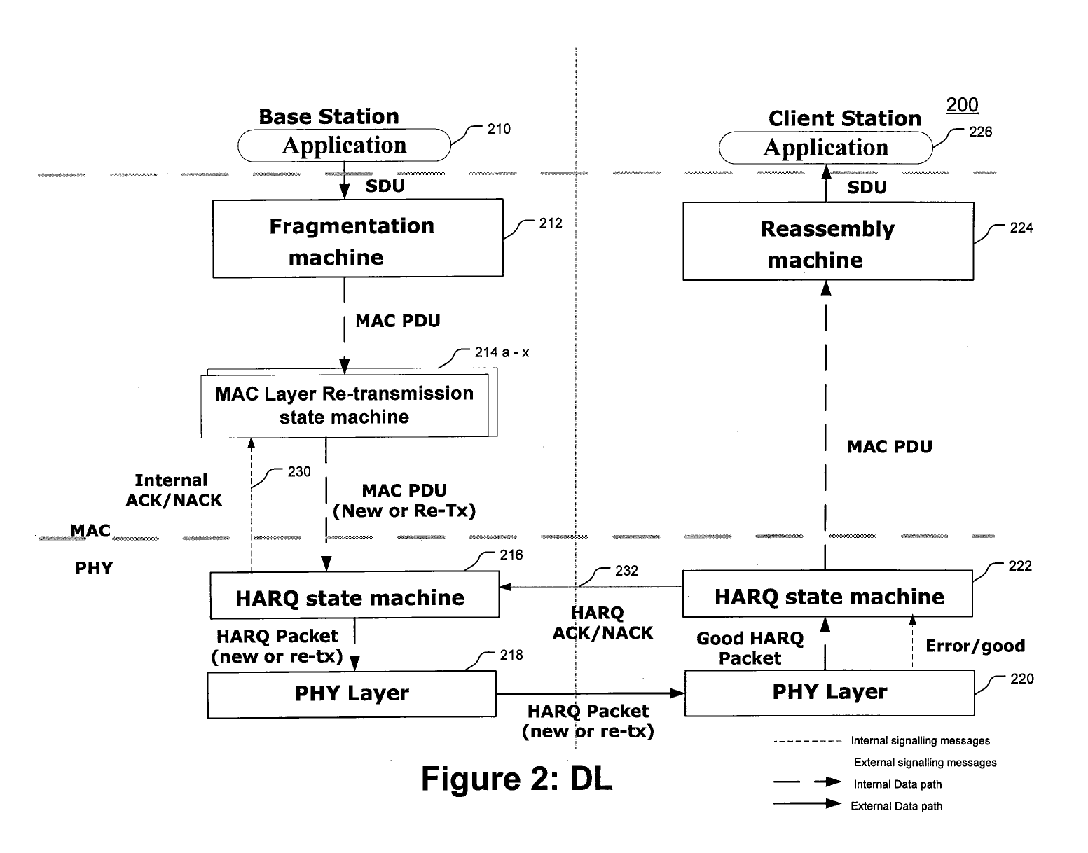

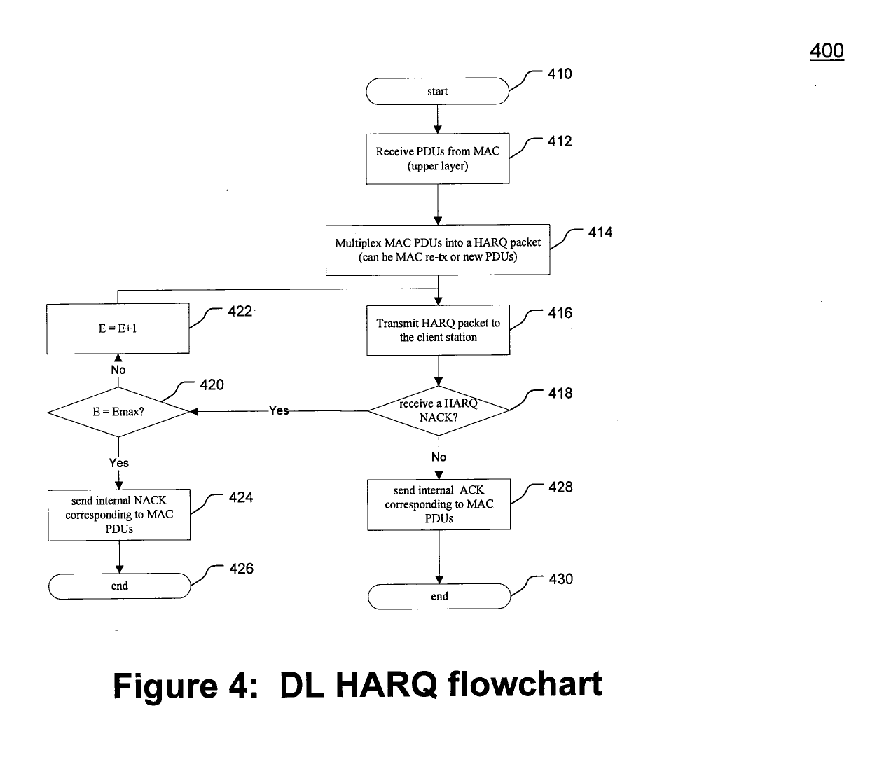

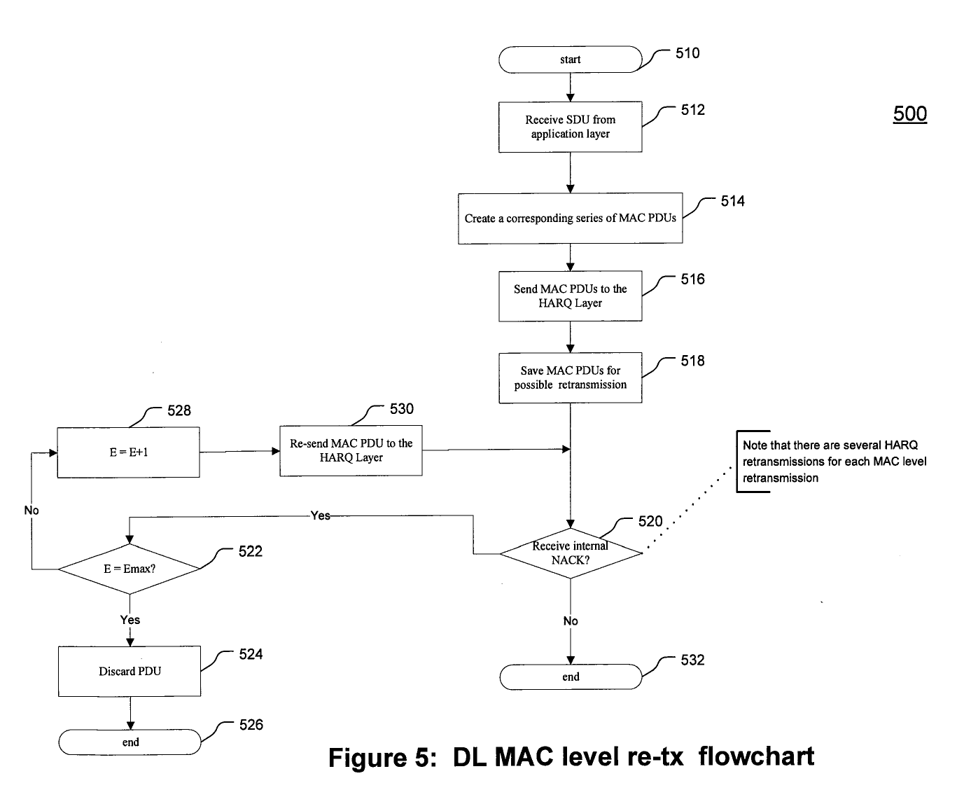

With reference to FIGS. 2, 4 and 5, an error control method in the DL operation according to one aspect of the invention is described hereinbelow. FIG. 2 is a block diagram illustrating a downlink service flow configuration 200 for error control from both the base station and client station perspectives. FIG. 4 is a simplified flow chart showing DL PHY layer operation 400 in the base station. FIG. 5 is a flow chart showing DL MAC layer operation 500 at the base station.

As seen in FIG. 2, for DL operation, the MAC layer of the base station comprises an application layer 210 configured to send one or more service data units (SDU) to a fragmentation machine 212 where a series of MAC PDUs are created based on the received SDUs. The base station also comprises a MAC layer retransmission state machine 214 that receives the MAC PDUs from the fragmentation machine and sends to a HARQ state machine 216 in the PHY layer 218 from which the MAC PDUs are sent to the client station. On the other hand, in the client station side, there is also a PHY layer 220 and HARQ state machine 222 from which the MAC PDUs are sent to a reassembly machine 224. The reassembly machine 224 then processes and reassembles the PDUs into SDUs to pass onto the application layer 226. During the above-mentioned transmission of data packets and interaction of each component, certain errors may occur. Below is described an exemplary DL service flow including error control at the base station.

The service flow starts in block 510 of FIG. 5. In block 512, the fragmentation machine 212 receives a service data unit (SDU) from the application layer 210. The fragmentation machine 212 creates a series of MAC PDUs in block 514 which are received by the MAC layer retransmission machine 214. Each PDU is assigned a unique service flow identifier (SFID) depending on its associated service or data connection. For example, if the client station is participating in a voice call while surfing the Internet, each of the voice and data connections is assigned a unique service flow identifier (SFID). In practice, separate MAC layer retransmission state machines (e.g., #a . . . , #x) can be used to further transmit the MAC PDUs to the HARQ state machine 216. In doing so, each MAC layer retransmission state machine 214 (e.g., #a, . . . , #x) will send one or more MAC PDUs of the same SFID to the HARQ state machine 216 through a different connection or service flow.

In block 518, the MAC layer retransmission state machine 214 saves a copy of the MAC PDUs for possible retransmission in case of transmission error or failure. In block 520, the MAC layer retransmission state machine 214 determines whether an internal NACK 230 was received from the HARQ state machine 216. If not, after a predetermined timer has expired, the service flow for this particular MAC PDU ends assuming it has been successfully received by the client station, although the general process may continue for other MAC PDUs associated with the SDU. When the timer expires, the MAC layer retransmission state machine 214 no longer needs to save this particular PDU for possible retransmission.

In block 520, if an internal NACK is received from the HARQ state machine before the timer expires, the service flow with regard to the particular MAC PDU continues to block 522 in which the PDU-associated MAC layer retransmission state machine 214 determines whether a maximum number of retransmissions has occurred with respect to the current PDU. If not, the flow continues to block 528 in which the retransmission counter is incremented. In block 530, the MAC layer retransmission state machine 214 resends the MAC PDU. If in block 522 the maximum number of retransmissions has been reached, the MAC layer retransmission state machine 214 discards this particular MAC PDU in block 524 and flow ends in block 526 for the particular MAC PDU, although the general flow may continue for other MAC PDUs associated with the SDU. In such a case, the application 210 will also experience error.

Referring now to FIG. 4, the DL PHY layer flow at the base station starts in block 410. In block 412, the HARQ state machine 216 receives the MAC PDU, such may have been sent by the MAC layer retransmission state machine 214 in either block 516 or 530 of FIG. 5. In one embodiment, the HARQ state machine 216 is capable of combining multiple MAC PDUs into one HARQ packet, as shown in block 414. In block 416, the core physical layer 218 transmits the HARQ packet over the wireless link to the client station. The HARQ state machine 216 awaits a response from the HARQ state machine 222 within the client station. If the HARQ state machine 216 receives a NACK in block 418, the flow continues to block 420, otherwise to block 428.

In block 420, the HARQ state machine 216 determines whether a maximum number of retransmissions has been exceeded. If not, the flow continues to block 422 where the retransmission error count is incremented. Subsequently, the HARQ state machine 216 retransmits the HARQ packet to the client station, as the flow goes back to block 416. If in block 420 the maximum number of retransmissions has been reached, the flow continues to block 424 in which the HARQ state machine 216 sends an internal NACK 230 to the MAC layer retransmission state machine 214 to indicate transmission error of the MAC PDUs and the flow ends in block 426. The creation of the internal NACK by the HARQ state machine 216 based on the physical layer error correction mechanisms obviates the need for the transmission of a MAC NACK over the wireless link, thus preserving the precious wireless link resources.

If in block 418, no HARQ NACK is received before a timer within the HARQ state machine 216 expires, the flow continues to block 428. In block 428, the HARQ state machine 216 sends an internal ACK 230 to MAC layer retransmission state machine 214. The creation of the internal ACK by the HARQ state machine 216 based on the physical layer error correction mechanisms obviates the need for the transmission of a MAC ACK over the wireless link, thus preserving the precious wireless link resources.

In FIG. 2, on the client station side, the core physical layer 220 responds in a standard HARQ manner sending error indications and good HARQ packets to the HARQ state machine 222. However, because of the operation as described in FIGS. 4 and 5, only successfully received MAC PDUs are passed from the HARQ state machine to the upper layers. Thus, the client station need not include a MAC layer retransmission state machine and the MAC PDUs from the HARQ state machine 222 can be passed directly to the reassembly state machine 224. The reassembly machine 224 reassembles the SDU and passes it to a corresponding application layer 226.

Although the HARQ ACK/NACK external signaling 232 is shown as flowing from the HARQ state machine 222 in the client station to the HARQ state machine 216 in the base station directly, according to industry standard practice in such a representation, the HARQ ACK/NACK message is typically transmitted via the core physical layers 218, 220.

As generally illustrated in FIGS. 2, 4, and 5, in the DL, the base station is the transmitter and the client station is the receiver. The BS relies on HARQ ACK/NACKs to drive MAC level retransmissions (ARQ). The BS keeps track of MAC PDUs mapping to HARQ packets and whether several MAC flows are multiplexed onto the same HARQ packet. The ARQ state machine can be advanced based on HARQ ACK/NACK. A window size of the NACK based ARQ can be managed using the Fragmentation Sequence Number (FSN).

If the HARQ packet is ACK'ed by the client station, the BS sends an internal ACK to the ARQ state machine for the associated MAC PDU. If the HARQ process is terminated with an unsuccessful outcome (independent of the maximum HARQ retransmission parameter), the BS sends an internal NACK indication for the associated PDUs. HARQ packets may carry multiple MAC flows. In this case, the base station may send internal ACK/NACK indications to multiple MAC flows state machines.

[As with any detection and retransmission technique, errors may occur due to the false indications of retransmission requests or failure to receive expected retransmissions. For example, a HARQ CRC false positive detection may be observed where a false indication is determined at the base station. This failure case typically cannot be detected independently. However, the occurrence of this type of error may be minimized or otherwise virtually eliminated through proper selection and implementation of a HARQ CRC that is sufficiently robust so that it meets the QoS requirements of connections.

For an UL feedback NACK-to-ACK detection error, there may be two possibilities. A first is where a Re-TX count<MAX Re-TX and a second occurs where the Re-TX count=MAX Re-TX. In the first instance, the client station receives New Packet Indicator (NPI)=1st Tx when it was expecting a retransmission assignment for the HARQ process ID. The client station can send an internal NACK indication for the associated MAC PDUs to trigger the ARQ retransmission. The internal NACK indication can be sent immediately. In the second instance, the New Packet Indicator (NPI) is not used to infer NACK-to-ACK detection error. Instead, the BS sends an internal ACK indication to the ARQ layer after a predetermined time. The client station repeats the NACK indication. There are at least two possible alternatives for a repeated NACK indication. In a first, MAC level NACK message; the client station sends a UL MAC signaling message to confirm the NACK. In a second alternative, PHY level NACK message; at the MAX retransmission event the client station gets two HARQ feedback channels, one for the current transmission, if any, and a second to confirm the previous NACK indications. The second alternative provides low overhead and fast indications.

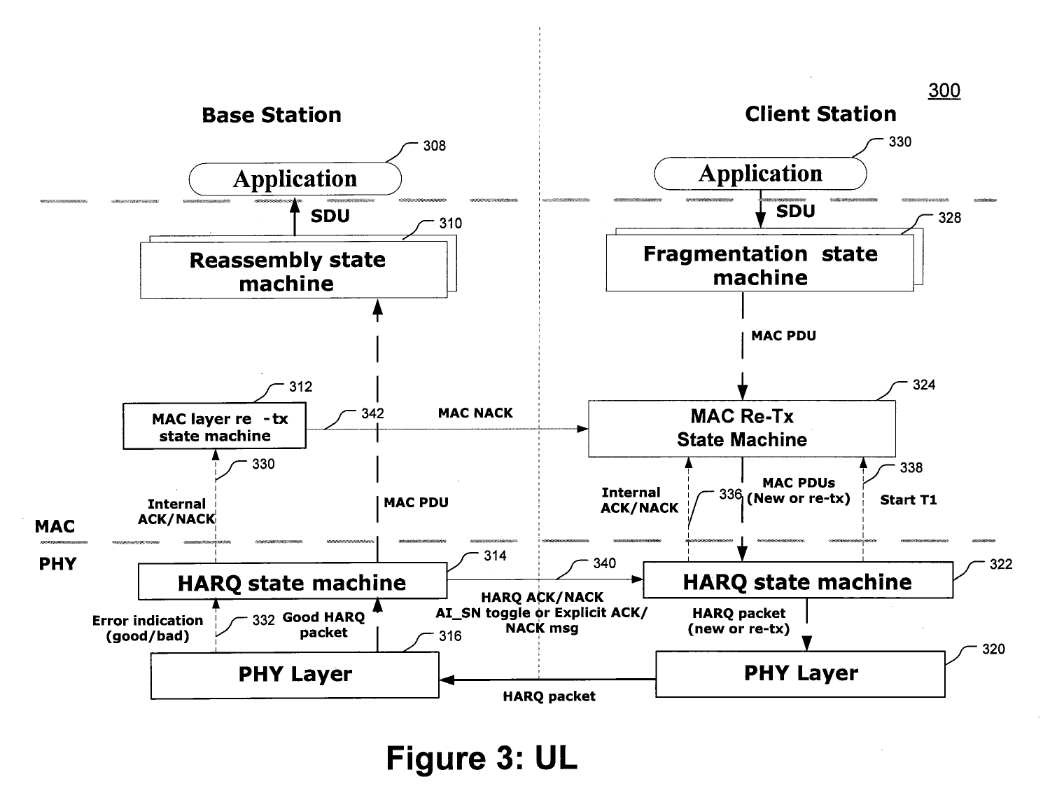

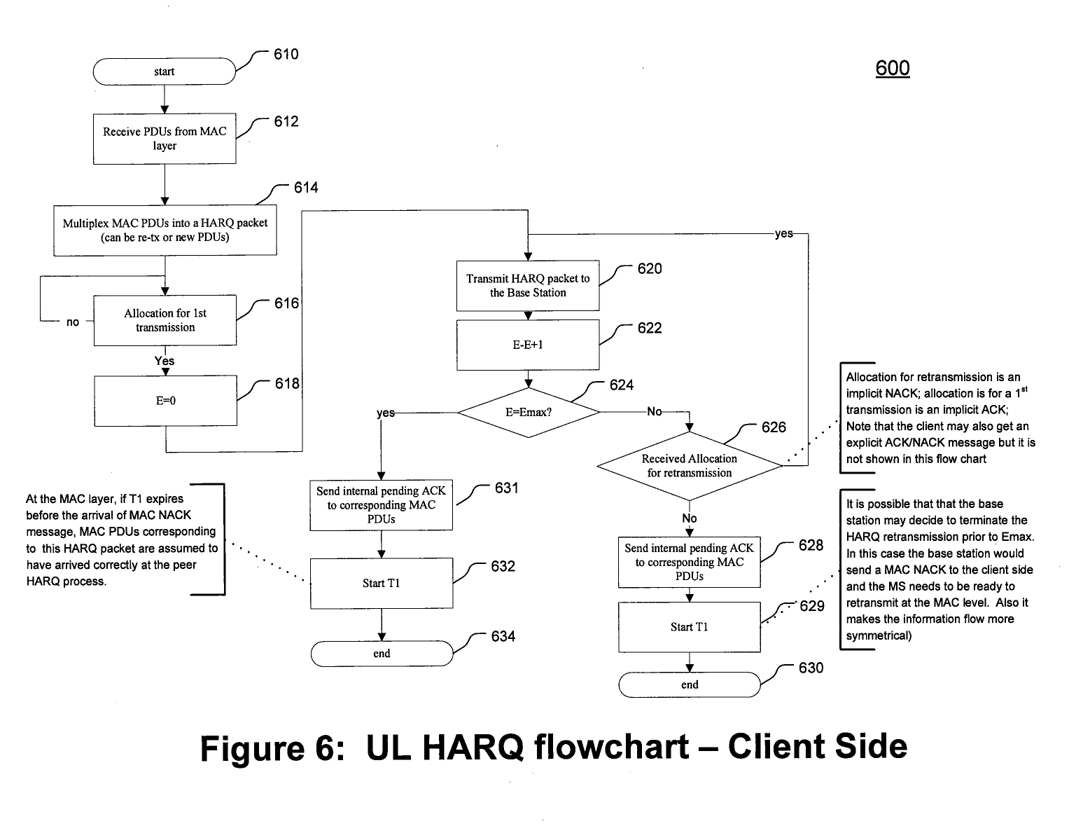

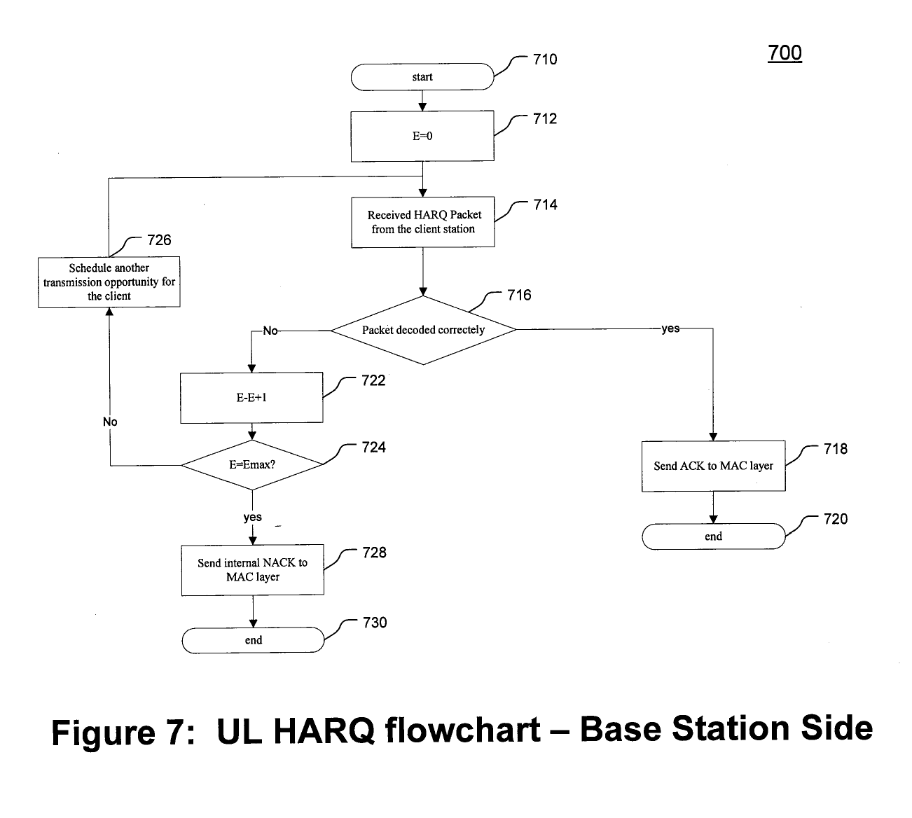

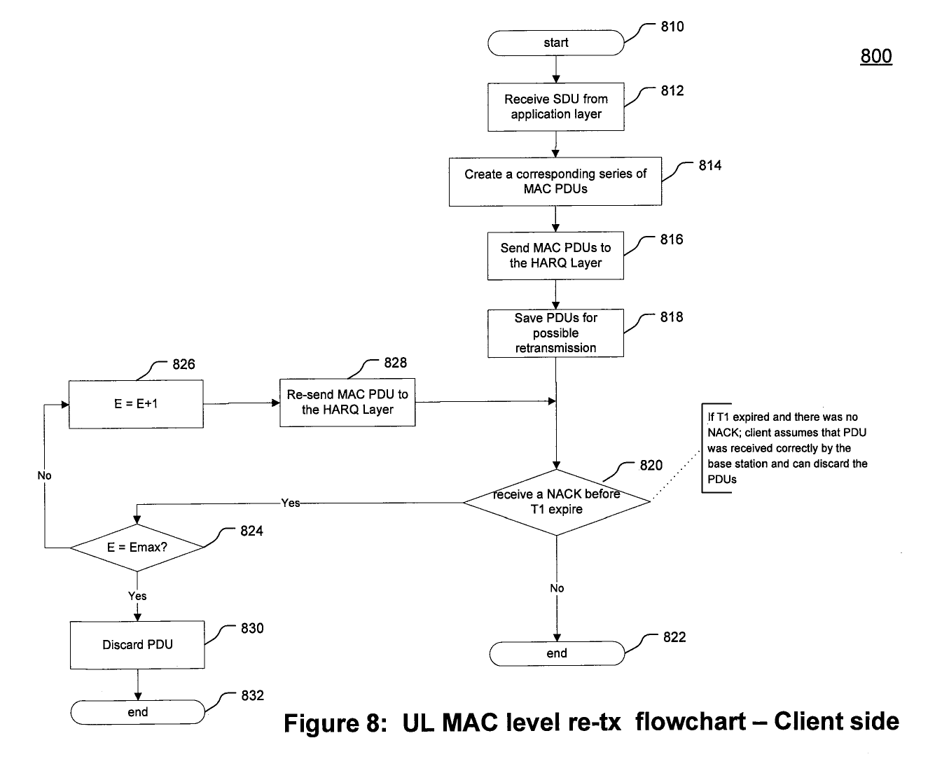

Referring now to FIGS. 3, 6-8, an exemplary UL flow between the client station and base station with improved error control mechanisms is herein described in detail. FIG. 3 is a block diagram illustrating an UL service flow configuration 300 from both base station and client station perspectives. FIG. 6 is an exemplary flow chart showing UL PHY layer operation 600 in the client station (transmitting station). FIG. 7 is an exemplary flow chart showing UL PHY layer operation 700 on the base station (receiving station). FIG. 8 is an exemplary flow chart showing UL MAC layer operation 800 at the client station (transmitting station).

As shown in FIG. 3, for UL operation, the client station comprises an application layer 330 that sends SDUs to a fragmentation state machine 328 where a series of MAC PDUs are created. The client station also comprises a MAC retransmission state machine 324 that receives MAC PDUs from the fragmentation state machine 328 and then sends them to a HARQ state machine 322 and a core PHY layer 320. On the base station side, in the PHY level there are a core PHY layer 316 and HARQ state machine 314 in communication with the client station. The base station also comprises a MAC layer retransmission state machine 312, a reassembly state machine 310 receiving MAC PDUs from the HARQ state machine 314 and reassembling them into SDUs, and an application layer 308 receiving SDUs from the reassembly state machine 310. Detailed transmission and interaction between the aforementioned components are described below, referring to the UL service flows in FIGS. 6-8.

The UL service flow starts at the MAC layer of the client station in block 810 of FIG. 8. In block 812, in the client station the fragmentation state machine 328 receives a service data unit (SDU) from the application layer 330. In block 814, the fragmentation state machine 328 creates a series of MAC PDUs based on the received SDU and provides them to the MAC retransmission state machine 324. In block 816, the MAC retransmission state machine 324 sends a MAC PDU to the HARQ state machine 322. In block 818, the MAC retransmission state machine 324 saves the MAC PDU value for possible retransmission. In block 820, the MAC retransmission state machine 324 sets a timer and monitors whether a NACK message is received before the timer expires. If a NACK is not received before the timer expires, the MAC retransmission state machine 324 assumes that this particular MAC PDU was successfully delivered across the wireless link to the base station and the flow ends for the MAC PDU of interest in block 822, although the general process may continue with respect to other MAC PDUs corresponding to the SDU.

If in block 820 a NACK is received before the timer expires, the flow continues to block 824 where the MAC retransmission state machine 324 determines whether a retransmission count has reached a maximum value. If not, the flow continues to block 826 in which the retransmission counter is incremented by one. In block 828, the MAC retransmission state machine 324 resends the MAC PDU to the HARQ state machine 322 and PHY layer 320.

Then the UL service flow continues to the PHY layer of the client station in start block 610 of FIG. 6. In block 612, the HARQ state machine 322 receives one or more MAC PDUs from the MAC retransmission state machine 324. The HARQ state machine 322 puts one or more MAC PDUs into an HARQ packet in block 614. In block 616, the HARQ state machine 322 awaits a grant of an uplink allocation from the base station. When the allocation is granted, the HARQ start machine 322 re-sets a retransmission counter in block 618. In block 620, the HARQ state machine 322 passes the HARQ packet to the core physical layer 320 which transmits it over the wireless link to the core physical layer 316 of the base station. The retransmission counter value is incremented by the HARQ state machine 322 in block 622.

In block 624, the HARQ state machine 322 determines whether a maximum retransmission counter value has been reached. If not, the flow continues to block 626 in which the HARQ state machine 322 determines whether a subsequent allocation grant is received for retransmission of the HARQ packet, which provides an implicit message whether the HARQ packet has been delivered successfully. This is because when the maximum number of retransmission has not been reached in this case, the receipt of a grant specifying the transmission of new information is a confirmation that the previous HARQ packet was properly received and, thus, is an implicit ACK. The receipt of a grant specifying a request to repeat previously sent information is an indication that the previous HARQ packet was not properly received and, thus, is an implicit NACK. Alternatively, the HARQ state machine 322 receives an explicit ACK or NACK message from the base station (not shown in FIG. 6) so as to decide whether retransmission is necessary.

[Referring back to block 26, if an allocation for retransmission is received, the flow goes back to block 620 where the HARQ state machine 322, again, passes the HARQ packet to the core physical layer 320 which transmits it over the wireless link to the core physical layer 316 of the base station. Conversely, if the allocation grant specifies the transmission of new information, the flow continues to block 628 in which the HARQ state machine 322 creates an internal pending ACK 336. In block 629, the HARQ state machine 322 sets a timer. If the timer expires before a MAC NACK 342 is received from the MAC layer retransmission state machine 312, the HARQ state machine 322 sends the internal ACK 336 to the MAC retransmission state machine 324 and the flow ends in block 630 for the HARQ packet of interest. On the other hand, if the MAC NACK 342 is received before the timer expires, the HARQ state machine 322 either sends an internal NACK 336 to the MAC retransmission state machine 324 or simply discards the internal pending ACK. Either way, the flow ends in block 630.

If the allocation specifies the retransmission of previously sent information, flow continues to block 620 and the processes of blocks 620, 622, 624 are repeated until the retransmission counter value (E) exceeds a predetermined value. For example, in one embodiment, the HARQ packet is sent to the base station up to four times. Once the retransmission counter value has reached its maximum value, the HARQ state machine 322 creates an internal pending ACK 336 in block 631. The HARQ state machine starts a timer in block 632. If the timer expires before receipt of a MAC NACK 342, the HARQ state machine 322 sends the internal ACK 336 to the MAC retransmission state machine 324. On the other hand, if the MAC NACK 342 is received before the timer expires, the HARQ state machine 322 either sends an internal NACK 336 to the MAC retransmission state machine 324 or simply discards the internal pending ACK. Either way, the flow ends in block 634.

On the base station side, the uplink flow in the physical layer begins in block 710 of FIG. 7. In block 712, the HARQ state machine 314 re-sets a retransmission counter value (E.) In block 714, the HARQ state machine 314 receives a good HARQ packet or a failure indication 332 from the core physical layer 316. If in block 716 a good HARQ packet was received, flow continues to block 718 where an internal ACK message 330 is sent to the MAC layer retransmission state machine 312, after which the flow ends in block 720 for the MAC PDU of interest. The transmission of the express internal ACK in block 718 obviates the need for the client station to send an explicit ACK message over the wireless link, thus preserving the precious wireless link resources.

If in block 716 the HARQ state machine 314 failed to properly receive the HARQ packet, the flow continues to block 722 in which the retransmission counter value is incremented. In block 724, the HARQ state machine 314 determines whether a maximum retransmission counter value has been reached. If the maximum retransmission counter value has not been reached, the HARQ state machine 314 requests an uplink allocation over which the client station can retransmit the HARQ packet. The scheduler (not shown) by way of this request is made aware of the need for retransmission and, in one aspect, can indicate such to the client station by using, for example, the AI_SN toggle bit 340 specified in WiMAX. On the other hand, if in block 724 the maximum retransmission counter value has been reached, the state machine 314 sends an internal NACK 330 to the MAC layer retransmission state machine 312, once again obviating the need for such a message to be sent over the wireless link.

The successfully received MAC PDU is passed from the HARQ state machine 314 to the reassembly state machine 310. The reassembly state machine 310 recreates the SDU based on the MAC PDU and passes it to an application layer 308.

One advantage of the operation as described above is that the MAC layer can react more quickly to a MAC layer error. Instead of relying on the expiration of a timeout value, in one embodiment, the MAC layer receives an explicit surrogate NACK message indicating whether the PHY layer fails to successfully transmit the PHY packet corresponding to the MAC PDU. Thus, even if the timeout value has not expired, the MAC layer can begin the retransmission process.

The uplink MAC ACK/NACK signaling mechanism as described above, such as with reference to FIGS. 3 and 6-8, can be applied to the downlink. For example, when there is a false-positive indication of a NACK sent from the client station which is mistakenly perceived as an ACK by the base station, similar response mechanisms can be used.

As generally illustrated in FIGS. 3, 6-8, in the UL, the client station is the transmitter and the BS is the receiver. The BS controls the HARQ retransmission operation for both HARQ and ARQ processes. The BS can use an implicit DL HARQ ACK/NACK indication using the New Packet Indicator (NPI). The New Packet Indicator (NPI) signals that the HARQ allocation is for a 1st transmission, or for a Re-Transmission HARQ packet. The transition point (NPI toggles) is interpreted by the client station HARQ as an ACK. The NPI can be sent as part of the assignment information using a DL control channel.

The client station keeps track of MAC PDUs mapping to HARQ packets. The client station assumes that a HARQ packet is implicitly ACKed using the new packet indication or after the maximum number of retransmission is reached. The client station sends an internal ACK for the associated PDUs after a predetermined time.

If the BS terminates the HARQ process unsuccessfully, it sends the client station a MAC level NACK. The BS must send the MAC level NACK before the predetermined time expires. The MAC level NACK uniquely identifies the HARQ packet so that the client station may trigger ARQ level retransmission for the associated MAC PDUs. For example, the NACK message may contain the HARQ process ID and the frame/sub-frame number in which the HARQ packet was received.

In the case of UL ARQ with an implicit DL HARQ ACK/NACK indication, regardless of the value of the Re-Tx count, if the client station receives a NPI=1st Tx, the client station sends an internal ACK indication to the ARQ layer after a predetermined time. If the last HARQ process was terminated unsuccessfully, which may be determined at the BS by a CRC check, the BS can send a MAC level NACK before the predetermined time to trigger ARQ retransmission. Note that BS MAC level NACK may be sent if the previous transmission was unsuccessful and the BS toggled the new packet indication. This is done regardless of the maximum retransmission count.

Potential detection errors that may affect the UL configuration include the loss of subsequent assignment information in the case of an asynchronous HARQ. In this case, the client station was not able to decode DL control channel and does not know if the new packet indicator was toggled. The client station, as a result, may not transmit on the designated UL allocation.

The BS can detect another NACK through the use of a CRC check. If the Re-TX Count<MAX Re-Tx, the BS sends another allocation with NPI=Re-Tx. Alternatively, if the Re-Tx count=MAX Re-Tx, the BS toggles the new packet indication to start a new process and sends an ARQ NACK message to the client station.

Although the illustrative examples included herein were generally directed toward using HARQ error control on the physical layer to direct ARQ error control on the media access layer, the principles described herein can be used with a variety of error control mechanisms on both the physical layer and the media access layer.

Methods and apparatus are described herein for using physical layer error control to direct media access layer error control.

As used herein, the term coupled or connected is used to mean an indirect coupling as well as a direct coupling or connection. Where two or more blocks, modules, devices, or apparatus are coupled, there may be one or more intervening blocks between the two coupled blocks.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosed embodiments. Various modifications to these embodiments will be readily apparent to those of ordinary skill in the art, and the generic principles defined herein may be applied to other embodiments without departing from the scope of the disclosure.

What is claimed is:

1. A method of transmitting data over a communication link using automatic repeat request (ARQ) and hybrid automatic repeat request (HARQ), the method comprising:
sending, by a local ARQ entity, one or more Protocol Data Units (PDUs) to a local HARQ entity;
receiving, by the local HARQ entity, the one or more PDUs from the local ARQ entity;
creating a HARQ packet from at least one of the one or more PDUs;
transmitting the HARQ packet over the communication link;
receiving over the communication link, by the local HARQ entity, a negative acknowledgement (NACK) of the HARQ packet;
sending, by the local HARQ entity to the local ARQ entity, an internal negative acknowledgement (internal NACK) identifying at least one of the one or more PDUs in the HARQ packet; and
re-sending, by the local ARQ entity to the local HARQ entity, at least one of the one or more PDUs identified in the internal NACK for re-transmission over the communication link.

2. The method of claim 1, wherein the receiving, over the communication link, the NACK of the HARQ packet includes receiving a bandwidth allocation for re-transmitting the HARQ packet.

3. The method of claim 1, further comprising:
sending the internal NACK to the local ARQ entity when the NACK has not been received over the communication link after a given amount of time following the transmission of the HARQ packet.

4. The method of claim 1, further comprising:
sending the internal NACK to the local ARQ entity when a positive acknowledgement (ACK) has not been received over the communication link after a given amount of time following the transmission of the HARQ packet.

5. The method of claim 1, further comprising:
stopping the re-sending of the at least one of the PDUs to the local HARQ entity by the local ARQ entity after a given number of retransmissions.

6. The method of claim 5, further comprising:
discarding, by the local ARQ entity, the at least one of the one or more PDUs indicated in the internal NACK if the given number of retransmissions is reached.

7. The method of claim 1, further comprising:
receiving, over the communication link, a positive acknowledgement (ACK) of the HARQ packet; and
sending at least one internal positive acknowledgement (internal ACK) to the local ARQ entity indicating at least one of the one or more PDUs in the HARQ packet.

8. A wireless node comprising:
local automatic repeat request (ARQ) circuitry configured to send one or more Protocol Data Units (PDUs) to local hybrid automatic repeat request (HARQ) circuitry;
the local HARQ circuitry configured to receive the one or more PDUs from the local ARQ circuitry;
transmission circuitry configured to create a HARQ packet from at least one of the one or more PDUs and to transmit the HARQ packet over the communication link; and
receiving circuitry configured to receive, over the communication link, a negative acknowledgement (NACK) of the HARQ packet;
wherein the transmission circuitry is further configured to retransmit the HARQ packet on a condition that a NACK of the HARQ packet is received,
wherein the local HARQ circuitry is further configured to send at least one local NACK to the local ARQ circuitry identifying at least one of the one or more PDUs in the HARQ packet, and
wherein the local ARQ circuitry is configured to resend, to the local HARQ circuitry, at least one of the one or more PDUs identified in the at least one local NACK.

9. The wireless node of claim 8, wherein the local HARQ circuitry is further configured to send the at least one local NACK to the local ARQ circuitry identifying at least one of the one or more PDUs on the condition that a NACK had not been received over the communication link after a given amount of time following the transmission of the HARQ packet.

10. The wireless node of claim 8, wherein the local HARQ circuitry is further configured to send the at least one local NACK to the local ARQ circuitry identifying at least one of the one or more PDUs on the condition that a positive acknowledgement (ACK) had not been received over the communication link after a given amount of time following the transmission of the HARQ packet.

11. The wireless node of claim 8, wherein the local ARQ circuitry is configured to stop resending of the at least one of the one or more PDUs to the local HARQ circuitry after a given number of retransmissions.

12. The wireless node of claim 11, wherein the local ARQ circuitry is configured to discard the at least one of the one or more PDUs identified indicated in the internal NACK if the given number of retransmissions is reached.

13. The wireless node of claim 11, wherein the local HARQ circuitry is further configured to send at least one local ACK to the local ARQ circuitry identifying at least one of the one or more PDUs on the condition that a positive acknowledgement (ACK) had been received over the communication link following the transmission of the HARQ packet.
